(19) United States
(12) Patent Application Publication
(10) Pub. No.: US 2014/0063339 A1
(43) Pub. Date: Mar. 6, 2014

(54) In Browser Muxing and Demuxing For Video Playback

(71) Applicant: Matias Cudich, San Francisco, CA (US)

(72) Inventor: Matias Cudich, San Francisco, CA (US)

(73) Assignee: GOOGLE INC., Mountain View, CA (US)

(21) Appl. No.: 13/603,247

(22) Filed: Sep. 4, 2012

(51) Int. Cl. H04N 7/01

(52) U.S. Cl. 348/441; 348/E07.008

(57) ABSTRACT

A system and method for converting a content file from a first format to a second format is disclosed. The system comprises a parser, a table generator, a determining module and a packaging module. The parser parses data in the content file with the first format for one or more file headers. The table generator generates one or more content tables based at least in part on the one or more file headers. The determining module determines one or more samples in the content file with the first format based at least in part on the one or more content tables. The packaging module generates one or more tags based at least in part on the one or more samples and converts the content file from the first format to the second format based at least in part on the one or more tags.

### BACKGROUND

The specification relates to a system for converting content file format such as video file format.

Numerous websites host videos for viewing by users. A video hosting site manages videos that are accessed by clients. Publishers upload video content to the video hosting site. The video hosting site pushes videos uploaded by publishers to the clients.

Sometimes the videos uploaded by publishers are stored on the video hosting site as video files with specific video file formats. For example, a publisher uploads a video with a Moving Picture Experts Group-4 (MPEG-4) video file format to a video hosting site. The uploaded video is stored on the video hosting site as an MPEG-4 video file. A user who accesses the video hosting site might want to view the video in a flash player on a user device such as a smart phone. Therefore, here comes a requirement of translating the MPEG-4 video file to a Flash Video (FLV) file since a flash player cannot play a video file with the MPEG-4 file format, but can play a video file with a FLV file format. Another requirement might be converting the video file format in real time once a user requests to view the video in a different format.

### SUMMARY

Embodiments disclosed herein provide a system and method for converting a content file from a first format to a second format. A browser comprises a flash player. The flash player comprises a format module. The format module comprises a parser, a table generator, a determining module and a packaging module. The parser parses data in the content file with the first format for one or more file headers. The table generator is communicatively coupled to the parser for receiving the one or more file headers and generating one or more content tables based at least in part on the one or more file headers. In one embodiment, the content table comprises one or more of a table identifier, a table name, a sample identifier, a sample name, a type, a byte offset, a length, a time offset and a motion feature.

The determining module is communicatively coupled to the table generator for receiving the one or more content tables from the table generator and determining one or more samples in the content file with the first format based at least in part on the one or more content tables. The packaging module is communicatively coupled to the determining module for receiving the one or more samples in the content file with the first format and generating one or more tags based at least in part on the one or more samples. The packaging module converts the content file from the first format to the second format based at least in part on the one or more tags.

The features and advantages described herein are not all-inclusive and many additional features and advantages will be apparent to one of ordinary skill in the art in view of the figures and description. Moreover, it should be noted that the language used in the specification has been principally selected for readability and instructional purposes, and not to limit the scope of the subject matter disclosed herein.

### BRIEF DESCRIPTION OF THE DRAWINGS

The specification is illustrated by way of example, and not by way of limitation in the figures of the accompanying drawings in which like reference numerals are used to refer to similar elements.

FIG. 1 is a high-level block diagram illustrating one embodiment of a system for converting content file format.

FIG. 2 is a block diagram illustrating one embodiment of a client device where a format module is illustrated in detail.

FIG. 3 is a block diagram illustrating one embodiment of a storage device.

FIG. 4 shows an example of a content table in accordance with an embodiment.

FIG. 5 is a flow diagram of one embodiment of a method for converting a content file from a first format to a second format.

FIG. 6 is a flow diagram of one embodiment of another method for converting a content file from a first format to a second format.

### DETAILED DESCRIPTION

A system and method for converting a content file from a first format to a second format is described below. In the following description, for purposes of explanation, numerous specific details are set forth in order to provide a thorough understanding of the specification. It will be apparent, however, to one skilled in the art that the embodiments can be practiced without these specific details. In other instances, structures and devices are shown in block diagram form in order to avoid obscuring the specification. For example, the specification is described in one embodiment below with reference to user interfaces and particular hardware. However, the description applies to any type of computing device that can receive data and commands, and any peripheral devices providing services.

Reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The specification also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

Some embodiments can take the form of an entirely hardware embodiment, an entirely software embodiment or an embodiment containing both hardware and software elements. A preferred embodiment is implemented in software, which includes but is not limited to firmware, resident software, microcode, etc.

Furthermore, some embodiments can take the form of a computer program product accessible from a computer-usable or computer-readable storage medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the specification is not described with reference to any particular programming language. It will be appreciated that a variety of programming languages may be used to implement the teachings of the various embodiments as described herein.

Finally, embodiments described herein include collection of data describing a user and/or activities of users. In one embodiment, such data is only collected upon the user providing consent to the collection of this data. In some implementations, a user is prompted to explicitly allow data collection. Further, the user may opt-in or opt-out of participating in such data collection activities. In one embodiment, the collected data is anonymized prior to performing any analysis to obtain any statistical patterns so that the identity of the user cannot be determined from the collected data.

### System Overview

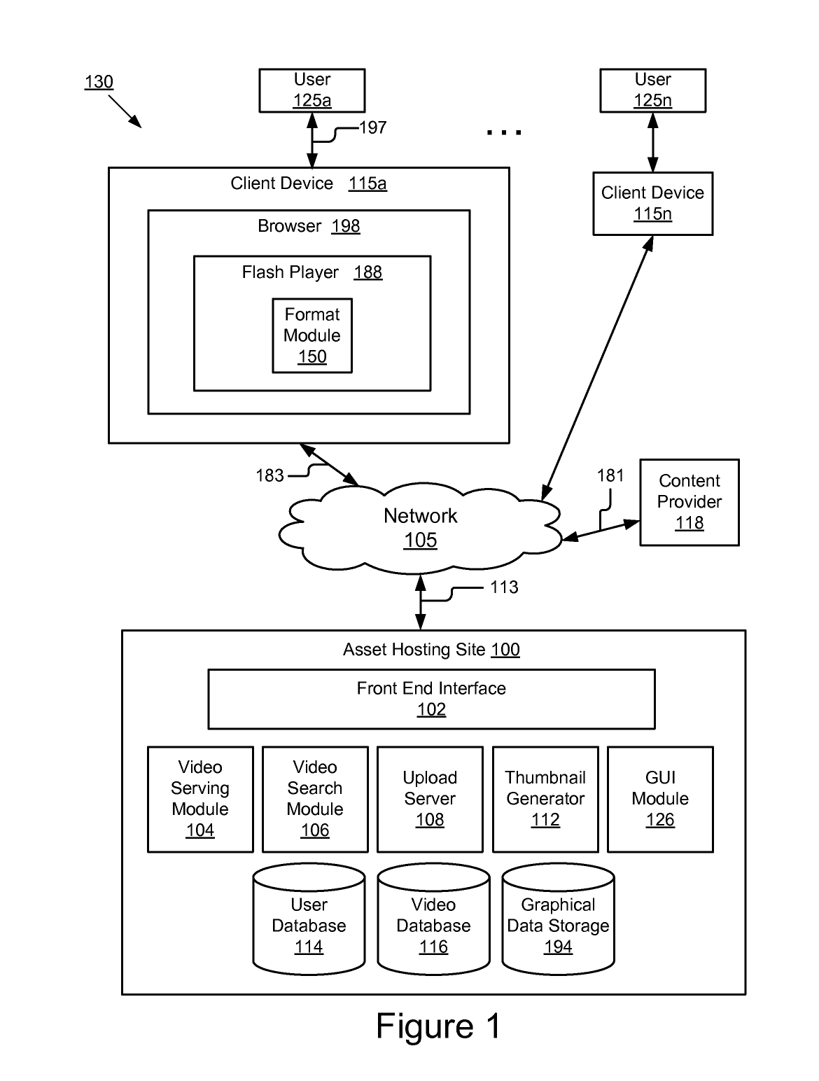

FIG. 1 illustrates a block diagram of a system 130 for converting content file format. The illustrated embodiment of the system 130 includes client devices 115a, 115n (also referred to collectively or individually as client devices 115) that are accessed by users 125a, 125n (also referred to collectively or individually as users 125), a content provider 118 and an asset hosting site 100. In the illustrated embodiment, these entities are communicatively coupled via a network 105. For example, the asset hosting site 100, the content provider 118 and the client devices 115 are communicatively coupled to one another via a network 105 to facilitate sharing of information (e.g., video content file) between users 125 of client devices 115.

Although one content provider 118, two client devices 115, and one asset hosting site 100 are illustrated in FIG. 1, persons having ordinary skill in the art will recognize that any number of content providers 118, client devices 115 and asset hosting sites 100 can be communicatively coupled to the network 105. Furthermore, while one network 105 is coupled to the client devices 115, the content provider 118 and the asset hosting site 100, persons having ordinary skill in the art will appreciate that any number of networks 105 can be connected to the client devices 115, the content provider 118 and the asset hosting site 100.

The network 105 is a conventional type, wired or wireless, and may have any number of configurations such as a star configuration, token ring configuration or other configurations known to those skilled in the art. Furthermore, the network 105 may comprise a local area network (LAN), a wide area network (WAN) (e.g., the Internet), and/or any other interconnected data path across which multiple devices may communicate. In yet another embodiment, the network 105 may be a peer-to-peer network. The network 105 may also be coupled to or include portions of a telecommunications network for sending data in a variety of different communication protocols. For example, the network 105 is a 3G network or a 4G network. In yet another embodiment, the network 105 includes Bluetooth communication networks or a cellular communications network for sending and receiving data such as via short messaging service (SMS), multimedia messaging service (MMS), hypertext transfer protocol (HTTP), direct data connection, WAP, e-mail, etc. In yet another embodiment, all or some of the links in the network 105 are encrypted using conventional encryption technologies such as secure sockets layer (SSL), secure HTTP and/or virtual private networks (VPNs).

In the illustrated embodiment, the content provider 118 is communicatively coupled to the network 105 via signal line 181. The client device 115a is coupled to the network 105 via signal line 183. The user 125a interacts with the client device 115a as represented by signal line 197. Client device 115n and user 125n are coupled and interact in a similar manner. The asset hosting site 100 is communicatively coupled to the network 105 via signal line 113.

The asset hosting site 100 is any system that allows users to access video content via searching and/or browsing interfaces. An example of an asset hosting site 100 is the YOUTUBE™ website, found at www.youtube.com. Other video hosting sites are known as well, and are adapted to operate according to the teachings disclosed herein. It will be understood that the term “website” represents any computer system adapted to serve content using any internet working protocols, and is not intended to be limited to content uploaded or downloaded via the Internet or the HTTP protocol.

In one embodiment, sources of the video content on the asset hosting site 100 are from uploads of videos by users, searches or crawls of other websites or databases of videos, or the like, or any combination thereof. For example, in one embodiment, the asset hosting site 100 is configured to allow uploading of video content by users 125 and/or the content provider 118. In another embodiment, the asset hosting site 100 is configured to obtain videos from other sources by crawling such sources or searching such sources in real time.

To simplify and clarify the present description, the video content files received and shared by the asset hosting site 100 will be referred to as videos, video files, or video items. Persons having ordinary skill in the art will recognize that the asset hosting site 100 can receive and share content of any media type and file type. For example, the asset hosting site 100 shares a content file such as a video, an audio, a combination of video and audio, an image such as a JPEG or GIF file and/or a text file, etc.

The asset hosting site 100 is communicatively coupled to the network 105 via signal line 113. In the illustrated embodiment, the asset hosting site 100 includes: a front end interface 102; a video serving module 104; a video search module 106; an upload server 108; a thumbnail generator 112; a GUI module 126; a user database 114; a video database 116; and a graphical data storage 194. The components of the asset hosting site 100 are communicatively coupled to one another. Other conventional features, such as firewalls, load balancers, authentication servers, application servers, failover servers, site management tools, and so forth are not shown so as not to obscure the feature of the system.

In one embodiment, the illustrated components of the asset hosting site 100 are implemented as single pieces of software or hardware or as multiple pieces of software or hardware. In general, functions described in one embodiment as being performed by one component, can also be performed by other components in other embodiments, or by a combination of components. Furthermore, functions described in one embodiment as being performed by components of the asset hosting site 100 are performed by one or more client devices 115 and/or content providers 118 in other embodiments, if appropriate. In one embodiment, the functionality attributed to a particular component is performed by different or multiple components operating together.

Each of the various servers and modules on the asset hosting site 100 is implemented as a server program executing on a server-class computer comprising one or more central processing units (“CPU,” or “CPUs” if plural), memory, network interface, peripheral interfaces, and other well-known components. In one embodiment, the computers themselves run an open-source operating system such as LINUX, have one or more CPUs, 1 gigabyte or more of memory, and 100 gigabytes or more of disk storage. In one embodiment, other types of computers are used, and it is expected that as more powerful computers are developed in the future, they are configured in accordance with the teachings disclosed herein. In another embodiment, the functionality implemented by any of the elements is provided from computer program products that are stored in one or more tangible, non-transitory computer-readable storage mediums (e.g., random access memory (“RAM”), flash, solid-state drive (“SSD”), hard disk drive, optical/magnetic media, etc.).

The front end interface 102 is an interface that handles communication with the content provider 118 and client devices 115 via the network 105. For example, the front end interface 102 receives video files uploaded from the content provider 118 and/or users 125 of the client devices 115 and delivers the video files to the upload server 108. In one embodiment, the front end interface 102 receives requests from users 125 of the client devices 115 and delivers the requests to the other components of the asset hosting site 100 (e.g., the video search module 106, the video serving module 104, etc.). For example, the front end interface 102 receives a video search query from a user 125 and sends the video search query to the video search module 106.

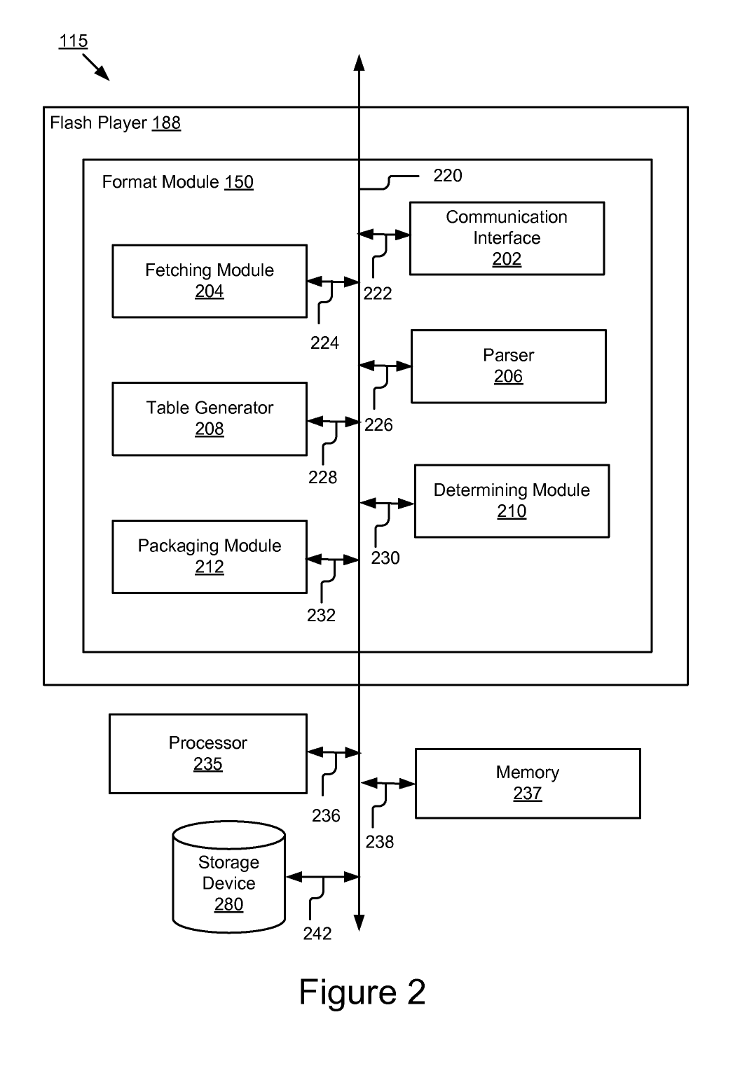

In another example, the front end interface 102 receives a request for data in a content file such as a video file with a MPEG-4 (“MP4”) file format from the client device 115. The front end interface 102 delivers the request to the video serving module 104. In one embodiment, the data that is requested includes one or more file headers. For example, the file header comprises supplemental data that is stored in the front of the video file such as the first one-half megabyte of the MP4 video file. In one embodiment, the supplemental data included in the file header describes the locations of one or more samples in the MP4 video file. The file header will be described in further detail below with reference to FIG. 2.

In yet another example, the front end interface 102 receives a request for one or more samples in a content file from the client device 115. For example, the content file is a MP4 video file and the sample in the MP4 video file includes one or more of an audio sample and a video sample. In one embodiment, an audio sample corresponds to an audio frame in the MP4 video file and a video sample corresponds to a video frame in the MP4 video file. The sample in a content file will be described in further detail below with reference to FIG. 2. In one embodiment, the front end interface 102 receives a request for a content file such as a video file from the client device 115.

In one embodiment, the front end interface 102 receives the retrieved data and/or the one or more samples in the video files from the video serving module 104. The front end interface 102 delivers the retrieved data and/or the one or more samples in the video files to the client devices 115 through the network 105. For example, the front end interface 102 receives data that includes a file header of a MP4 video file and sends the data to the client device 115.

The upload server 108 receives video files from the content provider 118 and/or users 125 operating on client devices 115 via the front end interface 102. In one embodiment, the video files have a MP4 file format. In one embodiment, the upload server 108 processes the video files and stores the video files in the video database 116. For example, the upload server 108 assigns a video identifier (video ID) to a video and stores the video and the video ID in the video database 116. Further examples of processing a video file by the upload server 108 include performing one or more of: formatting; compressing; metadata tagging; and content analysis, etc.

The video database 116 is a storage system that stores video files shared by the asset hosting site 100 with the users 125. In one embodiment, the video database 116 stores the video files received and/or processed by the upload server 108. For example, the video database 116 stores the video files with a MP4 file format. In another embodiment, the video database 116 stores metadata of the video files. For example, the video database 116 stores one or more of: a video title; a video ID; description; one or more keywords; tag information; and administrative rights of a video file. The administrative rights of a video file include one or more of: the right to delete the video file; the right to edit information about the video file; and the right to associate the video file with an advertisement, etc.

The video search module 106 includes code and routines that, when executed by a processor (not pictured), processes any search queries received by the front end interface 102 from a user 125 using a client device 115. A search query from a user 125 includes search criteria such as keywords that, for example, identify videos the user 125 is interested in viewing. In one embodiment, the video search module 106 uses the search criteria to query the metadata of video files stored in the video database 116. The video search module 106 returns the search results to the client device 115 via the front end interface 102. For example, if a user 125 provides a keyword search query to the video search module 106 via the front end interface 102, the video search module 106 identifies videos stored in the video database 116 matching the keyword and returns search results (e.g., video IDs, titles, descriptions, thumbnails of the identified videos) to the user 125 via the front end interface 102.

The video serving module 104 includes code and routines that, when executed by a processor (not pictured), processes requests for videos and serves videos to client devices 115. For example, the video serving module 104 receives a request for viewing a video from a user 125 of the client device 115, retrieves the video from the video database 116 based at least in part on the request and transmits the video to the client device 115 via the front end interface 102.

In one embodiment, the video serving module 104 receives a request from a client device 115 to access a video when the user 125 clicks on a link to the video. The request received from the client device 115 includes the video ID of the video. In one embodiment, the video ID is included automatically in the request once the user 125 clicks on the link for the video. The video serving module 104 uses the video ID to search and locate the video in the video database 116. Once the requested video is located, the video serving module 104 sends the video to the client device 115 via the front end interface 102.

In one embodiment, the video is presented to the user 125 on the client device 115. Metadata associated with the video such as the title and description of the video is also presented to the user 125. In one embodiment, the video serving module 104 stores the video ID of the video in the user database 114 after sending the video to the client device 115 so that a video viewing history of the user 125 is stored in the user database 114.

In one embodiment, the video serving module 104 receives a request for data in a video file from the client device 115. The request includes metadata of the video such as one or more of a video ID, a video title and one or more keywords of the video. The video serving module 104 searches and locates the video file based at least in part on the metadata included in the request. In one embodiment, the request also includes information describing a location and/or a length of the data in the video file. The video serving module 104 retrieves the data from the video file based at least in part on the information that describes the location and/or length of the data in the video file. Then the video serving module 104 transmits the data to the client device 115 via the front end interface 102.

In another embodiment, the video serving module 104 receives a request for one or more samples in a video file from the client device 115. Similarly, the request includes metadata of the video. The video serving module 104 locates the video file based at least in part on the metadata in the request. The request also indicates locations and/or lengths of the one or more samples in the video file. The video serving module 104 retrieves the one or more samples from the video file based at least in part on the request. The video serving module 104 then sends the one or more samples in the video file to the client device 115.

The user database 114 is a storage system that stores data and/or information associated with any user. For example, the user database 114 stores video IDs of video files uploaded by a user 125 so that a video uploading history of the user 125 is maintained in the user database 114. The user database 114 also stores video IDs of video files that the user 125 has accessed from the video database 116 for viewing so that a video viewing history for the user 125 is stored in the user database 114. In one embodiment, the user 125 is identified by using a unique user name and password and/or by using the user's 125n internet protocol address.

The thumbnail generator 112 includes code and routines that, when executed by a processor (not pictured), generates a thumbnail for a video. A thumbnail is an image that represents a video on the asset hosting site 100. For example, the thumbnail generator 112 analyzes the video and selects a frame from the video as the thumbnail. In one embodiment, the thumbnail generator 112 provides one or more images for the video and allows a publisher (e.g., a content provider 118 or a user 125 uploading the video using a client device 115) to select one image as the thumbnail.

The graphical data storage 194 is a storage system that stores graphical code for generating graphical user interfaces (“GUIs”) for display to the user 125 of the client device 115.

The GUI module 126 includes code and routines that, when executed by a processor (not pictured), generates a user interface that displays information to a user and/or allows a user to input information via the user interface. In one embodiment, the GUI module 126 provides the functionality described below for receiving inputs from users 125 and/or displaying information to users 125. The GUI module 126 is communicatively coupled to the front end interface 102. The GUI module 126 retrieves graphical data from the graphical data storage 194 and transmits the graphical data to the front end interface 102. The front end interface 102 communicates with the network 105 to transmit the graphical data to a processor-based computing device communicatively coupled to the network 105.

For example, the front end interface 102 transmits the graphical data to one or more of the content provider 118 and client device 115. One or more of the content provider 118 and the client device 115 receives the graphical data and generates a GUI displayed on a display device (e.g., a monitor) communicatively coupled to the content provider 118 and/or the client device 115. The GUI is displayed on a display device and viewed by a human user (e.g., a user such as a user 125). The GUI includes one or more fields, drop down boxes or other conventional graphics used by the human user to provide inputs that are then transmitted to the asset hosting site 100 via the network 105. Data inputted into the GUI is received by the front end interface 102 and stored in one or more of the video database 116 and user database 114.

The client device 115 is any computing device. For example, the client device 115 is a personal computer (“PC”), smart phone, tablet computer (or tablet PC), etc. One having ordinary skill in the art will recognize that other types of client devices 115 are possible. In one embodiment, the system 130 comprises a combination of different types of client devices 115. For example, a plurality of other client devices 115 is any combination of a personal computer, a smart phone and a tablet computer.

In one embodiment, the client device 115 comprises a browser 198. The browser 198 includes code and routines stored in a memory (not pictured) of the client device 115 and executed by a processor (not pictured) of the client device 115. For example, the browser 198 generates a browser application such as Google Chrome. In one embodiment, the browser 198 comprises a flash player 188 and the flash player 188 comprises a format module 150.

While the format module 150 is illustrated as part of the flash player 188, persons having ordinary skill in the art will recognize that the format module 150 could reside on either the browser 198 or the asset hosting site 100. Although the browser 198, the flash player 188 and the format module 150 are shown in reference to the client device 115a, persons having ordinary skill in the art will recognize that any client device 115 may comprise these elements. Although one browser 198, one flash player 188 and one format module 150 are illustrated in reference to the client device 115, persons having ordinary skill in the art will recognize that any number of browsers 198, flash players 188 and format modules 150 can be comprised in the client device 115.

In one embodiment, the flash player 188 includes code and routines that, when executed by a processor (not pictured) of the client device 115, generates a flash player interface embedded in a browser application such as Google Chrome playing a content file such as a video. For example, responsive to a user 125 requesting to view a video in a flash player interface, the flash player 188 generates the flash player interface that plays the video with a FLV file format.

In one embodiment, the format module 150 includes code and routines that, when executed by a processor (not pictured) in the client device 115, converts a content file such as a video file from a first format to a second format. For example, the format module 150 converts a video file from a MP4 file format to a FLV file format.

In one embodiment, the format module 150 generates a request for data in a content file such as a video file with a first format when the user 125 clicks to view the video file in a second format if the video file with the second format is not available. For example, when a user 125 requests to view a video file in a flash player interface which requires a FLV file format, the format module 150 generates a request for data in the video file with an MP4 format that is stored in the asset hosting site 100 if there is no such video file with the FLV format available in the asset hosting site 100. In one embodiment, the request includes one or more of a video ID, a video title and one or more keywords of the video file. In another embodiment, the request also includes information that describes the location and/or the length of the data in the video file. The format module 150 transmits the request to the video serving module 104 in the asset hosting site 100 via the front end interface 102. In one embodiment, the format module 150 receives the data in the video file from the video serving module 104 and processes the data. For example, the format module 150 parses the data and converts the video file from the MP4 file format to the FLV file format. The format module 150 then sends the FLV file to other components of the flash player 188 to present the video on the client device 115 for the user 125.

### Format Module 150

Referring now to FIG. 2, depicted is an embodiment of a client device 115 showing the format module 150 in more detail. Specifically, FIG. 2 depicts a processor 235, a memory 237, a storage device 280 and the flash player 188 including the format module 150.

In one embodiment, the processor 235 is a computer processor of the client device 115, and can be used to execute code and routines. The processor 235 comprises an arithmetic logic unit, a microprocessor, a general purpose controller or some other processor array to perform computations and execute code and routines. The processor 235 is coupled to the bus 220 for communication with the other components of the client device 115. Processor 235 processes data signals and may comprise various computing architectures including a complex instruction set computer (CISC) architecture, a reduced instruction set computer (RISC) architecture, or an architecture implementing a combination of instruction sets. Although only a single processor is shown in FIG. 2, multiple processors may be included. The processing capability may be limited to supporting the display of images and the capture and transmission of images. The processing capability might be enough to perform more complex tasks, including various types of feature extraction and sampling. It will be obvious to one skilled in the art that other processors, operating systems, sensors, displays and physical configurations are possible. The processor 235 is communicatively coupled to the bus 220 via signal line 236.

The memory 237 is a non-transitory storage medium. The memory 237 stores instructions and/or data that may be executed by the processor 235. For example, in one embodiment, the memory 237 stores the format module 150. The memory 237 is communicatively coupled to the bus 220 for communication with the other components of the client device 115. In one embodiment, the instructions and/or data stored on the memory 237 comprises code for performing any and/or all of the techniques described herein. The memory 237 is a dynamic random access memory (DRAM) device, a static random access memory (SRAM) device, flash memory or some other memory device known in the art. In one embodiment, the memory 237 also includes a non-volatile memory or similar permanent storage device and media such as a hard disk drive, a floppy disk drive, a CD-ROM device, a DVD-ROM device, a DVD-RAM device, a DVD-RW device, a flash memory device, or some other non-volatile storage device known in the art. The memory 237 is communicatively coupled to the bus 220 via signal line 238. In one embodiment, the memory 237 stores the format module 150 and the sub-modules 202, 204, 206, 208, 210 and 212 that are included in the format module 150.

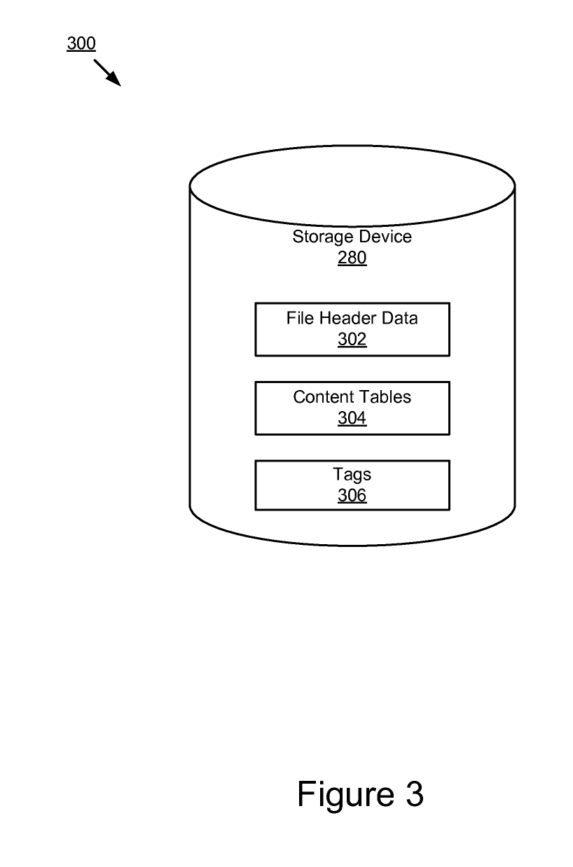

The storage device 280 is a non-transitory memory that stores data generated and/or received by the format module 150 or its sub-modules and other data necessary to perform the functionality described below. The storage device 280 will be described in further detail below with reference to FIG. 3.

In one embodiment, the format module 150 comprises a communication interface 202, a fetching module 204, a parser 206, a table generator 208, a determining module 210 and a packaging module 212.

The communication interface 202 includes code and routines for handling communications between the fetching module 204, the parser 206, the table generator 208, the determining module 210, the packaging module 212, other components (not pictured) of the client device 115 and the components of the asset hosting site 100. In one embodiment, the communication interface 202 is a set of instructions executable by the processor 235. In another embodiment, the communication interface 202 is stored in the memory 237 and is accessible and executable by the processor 235. In either embodiment, the communication interface 202 is adapted for cooperation and communication with the processor 235 and other components of the client device 115 via signal line 222. The communication interface 202 is communicatively coupled to the bus 220 via signal line 222.

In one embodiment, the communication interface 202 receives a message from other components (not pictured) of the client device 115 when a user 125 requests to view a video file in a flash player interface embedded in a browser such as Google Chrome. The communication interface 202 delivers the message that indicates the requesting of the user 125 to the fetching module 204. In another embodiment, the communication interface 202 receives a request for data in a content file such as a video file from the fetching module 204 and transmits the request to the video serving module 104 included in the asset hosting site 100 via the front end interface 102. In yet another embodiment, the communication interface 202 receives a request for one or more samples in a content file from the determining module 210. The communication interface 202 sends the request to the video serving module 104 in the asset hosting site 100 via the front end interface 102.

In one embodiment, the communication interface 202 receives data in the content file from the video serving module 104 via the front end interface 102. For example, the data includes one or more file headers for the content file such as a video file. The communication interface 202 sends the received data to the parser 206 for parsing the data. In another embodiment, the communication interface 202 receives one or more samples in the content file from the video serving module 104 via the front end interface 102. The communication interface 202 delivers the received one or more samples to the determining module 210 to parse the one or more samples.

In one embodiment, the communication interface 202 also communicates with the packaging module 212 and other components (not pictured) of the client device 115 to pass the output of the packaging module 212 (a content file with a converted file format such as a FLV file) to the other components (not pictured) of the client device 115 such as some related components of the flash player 188. This way, the content file can be played in the flash player interface.

In one embodiment, the communication interface 202 also handles the communications between other sub-modules 204, 206, 208, 210 and 212 in the format module 150. For example, the communication interface 202 communicates with the table generator 208 and the determining module 210 to pass the output of the table generator 208 (one or more content tables) to the determining module 210. However, this description may occasionally omit mention of the communication interface 202 for purposes of clarity and convenience. For example, for purposes of clarity and convenience, the above scenario may be described as the table generator 208 passing one or more content tables to the determining module 210.

The fetching module 204 includes code and routines for fetching data in the content file from the asset hosting site 100. In one embodiment, the fetching module 204 is a set of instructions executable by the processor 235 to provide the functionality described below for fetching data in the content file from the asset hosting site 100. In another embodiment, the fetching module 204 is stored in the memory 237 and is accessible and executable by the processor 235. In either embodiment, the fetching module 204 is adapted for cooperation and communication with the processor 235 and other components of the client device 115 via signal line 224. The fetching module 204 is communicatively coupled to the bus 220 via signal line 224.

In one embodiment, the fetching module 204 generates a request for data in a content file with a first format responsive to receiving a message that indicates a user 125 requesting to view the content file in a second format. For example, the fetching module 204 receives a message from the communication interface 202 indicating that a user 125 requests to view a video in a flash player interface when the user 125 clicks on a link to the FLV format video in a playlist included in the flash player interface. Based at least in part on the received message, the fetching module 204 generates a request for data in a video file with an MP4 format that is stored in the asset hosting site 100 if there is no such a video file with a FLV format available in the asset hosting site 100. For example, the fetching module 204 retrieves metadata of the video file (such as a video ID, a video title and a keyword) from the received message and generates the request including the metadata.

In another embodiment, the fetching module 204 generates the request for data in a content file with a first format periodically such as in a pre-determined time interval (e.g., a day, a week, a month). In yet another embodiment, the fetching module 204 generates the request for data in a content file with a first format such as a MP4 video file once the MP4 video file is uploaded by a user 125 of a client device 115 or by a content provider 118.

In one embodiment, the request includes one or more of a video ID, a video title and a keyword of the video. In another embodiment, the request also includes information describing one or more of a location and a length of the data. For example, the request includes one or more of a start byte, an end byte, a start time and an end time to indicate the location of the requested data. In another example, the request includes one or more of a length in byte (such as two megabytes) and a time length (such as three seconds) of the requested data.

In one embodiment, the fetching module 204 transmits the request for data in the content file with a first format to the communication interface 202 and the communication interface 202 delivers the request to the video serving module 104 in the asset hosting site 100 via the network 105.

The parser 206 includes code and routines for parsing data in content files for one or more file headers. In one embodiment, the parser 206 is a set of instructions executable by the processor 235 to provide the functionality described below for parsing data in content files for one or more file headers. In another embodiment, the parser 206 is stored in the memory 237 and is accessible and executable by the processor 235. In either embodiment, the parser 206 is adapted for cooperation and communication with the processor 235 and other components of the client device 115 via signal line 226. The parser 206 is communicatively coupled to the bus 220 via signal line 226.

In one embodiment, the parser 206 receives the data in the content file with the first format from the asset hosting site 100 through the communication interface 202. The parser 206 parses the data at byte level for one or more file headers. For example, the content file is a MP4 video file. The parser 206 parses the data at byte level for a file header for the MP4 video file. In one embodiment, the file header includes supplemental data (such as a number of bytes) that describes locations of one or more samples (such as video samples, audio samples) in the MP4 video file. For example, the file header includes one megabyte indicating one or more of byte offsets and time offsets of the one or more samples in the MP4 video file. In another embodiment, the file header also includes a number of bytes indicating one or more of types of the samples, lengths of the samples, motion features of the samples if the samples are video samples and any other features about the samples.

In one embodiment, the parser 206 sends the parsed data to the table generator 208. For example, the parser 206 sends the one or more file headers that include supplemental data to the table generator 208 to generate one or more content tables based on the one or more file headers. In one embodiment, the parser 206 sends the one or more file headers to the storage device 280 for storage.

In one embodiment, the parser 206 receives one or more samples of a content file and parses the samples based on one or more content tables that contain descriptions of the samples. The content tables and the samples will be described in further detail below with reference to the table generator 208 and the determining module 210.

The table generator 208 includes code and routines for generating one or more content tables based at least in part on the one or more file headers. In one embodiment, the table generator 208 is a set of instructions executable by the processor 235 to provide the functionality described below for generating one or more content tables based at least in part on the one or more file headers. In another embodiment, the table generator 208 is stored in the memory 237 and is accessible and executable by the processor 235. In either embodiment, the table generator 208 is adapted for cooperation and communication with the processor 235 and other components of the client device 115 via signal line 228. The table generator 208 is communicatively coupled to the bus 220 via signal line 228.

In one embodiment, the table generator 208 receives the parsed data including one or more file headers from the parser 206. In another embodiment, the table generator 208 retrieves one or more file headers from the storage device 280. In either embodiment, the table generator 208 generates one or more content tables based at least in part on the one or more file headers.

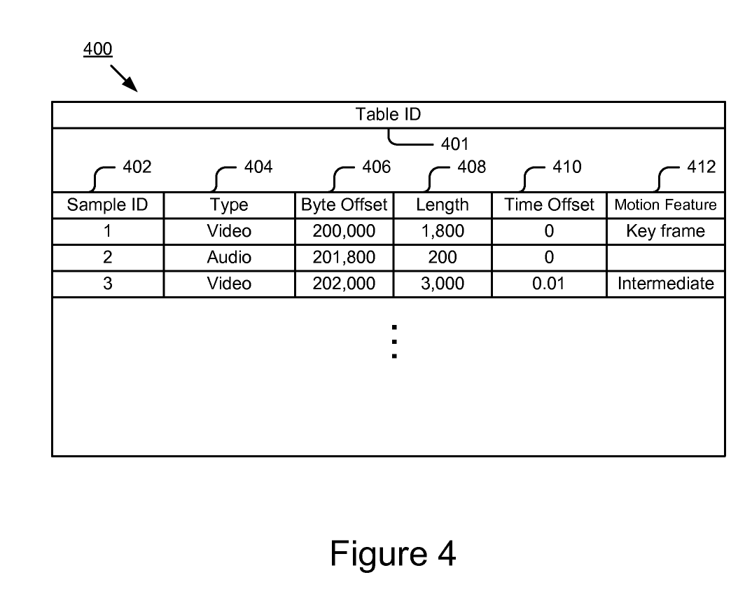

For example, the table generator 208 generates a content table that contains one or more entries. Each entry in the content table corresponds to one sample in the content file. The table generator 208 uses the supplemental data included in the file headers to populate the one or more entries in the content table. For example, an entry in the content table includes one or more of a type of the sample (such as video and audio), a byte offset (e.g., the start byte of the sample in the content file), a length in byte, a time offset (e.g., the start time of the video or the audio frame that the sample corresponds to) and a motion feature (e.g., the feature of the video frame that the sample corresponds to such as key frame and intermediate frame). The content table will be described in further detail below with reference to FIG. 3 and FIG. 4.

In one embodiment, the table generator 208 assigns a sample identifier (“sample ID”) to a sample. For example, the table generator 208 assigns a sample in a video file a sample ID that indicates the index of the sample in the video file. The table generator 208 populates the entry in the content table that corresponds to the sample in the video file with the sample ID. In another embodiment, the table generator 208 generates a table identifier (“table ID”) to a content table. The table generator 208 prepends the table ID to the index to form the sample ID for the sample. For example, the table generator 208 generates a content table for a video file and assigns a table ID for the content table. The table generator 208 generates a sample ID for a sample in the video file using the table ID and an index of the sample. In another example, the table generator 208 generates more than one content table for one content file. The table generator 208 assigns table IDs for the content tables and generates sample IDs for samples accordingly.

In one embodiment, the table generator 208 also generates one or more tables of a content table. For example, the table of content indicates the relationship between one or more content tables and one or more content files. In one entry of the table of contents, for example, a content table ID is listed to correspond to a content ID such as a video ID that refers to a content file such as a video file.

In one embodiment, the table generator 208 transmits the one or more content tables and/or the one or more tables of content to the determining module 210. In another embodiment, the table generator 208 sends the one or more content tables and/or the one or more tables of content to the storage device 280 for storage. In yet another embodiment, the table generator 208 also transmits the one or more content tables and/or the one or more tables of content to the packaging module 212.

The determining module 210 includes code and routines for determining one or more samples in the content file based at least in part on the one or more content tables. In one embodiment, the determining module 210 is a set of instructions executable by the processor 235 to provide the functionality described below for determining one or more samples in the content file. In another embodiment, the determining module 210 is stored in the memory 237 and is accessible and executable by the processor 235. In either embodiment, the determining module 210 is adapted for cooperation and communication with the processor 235 and other components of the client device 115 via signal line 230. The determining module 210 is communicatively coupled to the bus 220 via signal line 230.

In one embodiment, the determining module 210 receives the one or more content tables from the table generator 208. In another embodiment, the determining module 210 retrieves the one or more content tables from the storage device 280. In either embodiment, the determining module 210 determines one or more samples in the content file based at least in part on the one or more content tables.

A sample in a video content file corresponds to a frame of the video such as a video frame and an audio frame. The sample corresponding to a video frame or an audio frame is called a video sample or an audio sample, respectively. The sample in a content file such as an MP4 video file includes a number of bytes. For example, a video sample in an MP4 video file includes 1,500-3,000 bytes and an audio sample in an MP4 video file includes 150-300 bytes. A key frame sample indicates that the video frame that the sample represents is a key frame. A key frame defines either a starting point or an ending point of a transition of a motion in a video.

In one embodiment, the determining module 210 analyzes the one or more entries in the one or more content tables and determines the locations of the one or more samples in the content file. For example, the determining module 210 retrieves the byte offset (such as 200,000 bytes) and length (such as 1,800 bytes) for a sample with a sample ID “1” from an entry in the content table. The determining module 210 then analyzes the retrieved information and determines that the sample “1” starts at the No. 200,000 byte in the content file and ends 1,800 bytes after the No. 200,000 byte (e.g., No. 201,800 byte).

In one embodiment, the determining module 210 also retrieves one or more samples from the content file based on the determination. For example, the determining module 210 generates a request for one or more samples in the content file such as a video file with a MP4 format and transmits the request to the asset hosting site 100 via the communication interface 202. In one embodiment, the request for one or more samples includes the information that describes the locations of the one or more samples in the content file.

In one embodiment, the determining module 210 retrieves the one or more samples in the order indicated by the sample IDs in the content table. In another embodiment, the determining module 210 retrieves a pre-determined number of bytes from the content file. The pre-determined number of bytes includes one or more samples.

In one embodiment, the determining module 210 includes a parser (not pictured) that parses the retrieved one or more samples at byte level based at least in part on the one or more content tables. In another embodiment, the determining module 210 transmits the retrieved one or more samples to the parser 206. The parser 206 parses the one or more samples at byte level based at least in part on the one or more content tables. For example, in either embodiment, the one or more samples are parsed according to the byte offset, the length in byte and other features in the one or more content tables.

The packaging module 212 includes code and routines for generating one or more tags based at least in part on the one or more samples from a content file and converting the content file format based at least in part on the tags. In one embodiment, the packaging module 212 is a set of instructions executable by the processor 235 to provide the functionality described below for generating one or more tags based at least in part on the one or more samples from a content file and converting the content file format based at least in part on the tags. In another embodiment, the packaging module 212 is stored in the memory 237 and is accessible and executable by the processor 235. In either embodiment, the packaging module 212 is adapted for cooperation and communication with the processor 235 and other components of the client device 115 via signal line 232. The packaging module 210 is communicatively coupled to the bus 220 via signal line 232.

In one embodiment, the packaging module 212 receives the one or more parsed samples from the determining module 210. In another embodiment, the packaging module 212 receives the one or more parsed samples from the parser 206. In either embodiment, the packaging module 212 generates one or more tags based at least in part on the one or more parsed samples.

A tag includes one or more tag headers and one or more samples. A tag header includes data that describes one or more samples. For example, a tag includes a tag header and a sample. The tag header includes one or more of a tag type, a tag length, a time offset and a motion feature. The tag type corresponds to the type of the sample. For example, the type of the sample includes audio and video. The tag length corresponds to the length of the sample and the time offset is the time offset of the sample. The motion feature indicates whether the frame that the sample corresponds to is a key frame or an intermediate frame. In one embodiment, a tag header for a video sample includes 16 bytes. In another embodiment, a tag header for an audio sample includes 13 bytes that describes the features of the audio sample.

In one embodiment, the packaging module 212 generates one or more tag headers based at least in part on the one or more content tables. For example, the packaging module 212 retrieves the one or more content tables from the storage device 280. In another example, the packaging module 212 receives the one or more content tables from the table generator 208. The packaging module 212 uses one or more entries in the content tables to generate a tag header with 16 bytes describing the features for a video sample. The tag header includes a tag type (e.g., type of the sample such as video), a tag length (e.g., the length of the sample), the time offset and the motion feature.

In one embodiment, the packaging module 212 prepends the one or more tag headers to the one or more samples to form a tag. For example, the packaging module 212 prepends a tag header for a video sample to the video sample to form a video tag (e.g., a tag with a video type).

In one embodiment, the packaging module 212 transmits the one or more tags in sequence to other components of the flash player 188 to play the video file in the flash player interface included in a browser application such as Google Chrome. In another embodiment, the packaging module 212 sends the one or more tags to the storage device 280 for storage.

In one embodiment, optionally the packaging module 212 generates a script tag and inserts the script tag into a sequence of video and audio tags. The script tag allows the flash player 188 to add a callback function that will be executed when the script tag is decoded.

### Storage Device 280

FIG. 3 is a block diagram 300 illustrating one embodiment of the storage device 280. In the depicted embodiment, the storage device 280 includes file header data 302, content tables 304 and tags 306. Persons of ordinary skill in the art will recognize that the storage device 280 may store additional data not depicted in FIG. 3, such as samples in video files.

The file header data 302 is data in a content file such as a video file that is fetched from the asset hosting site 100 by the fetching module 204 and parsed by the parser 206. In one embodiment, the file header data 302 includes one or more file headers for one or more content files such as MP4 video files that are stored in the asset hosting site 100. In one embodiment, a file header includes supplemental data that describes one or more features for one or more samples in a content file such as an MP4 video file. The features includes one or more of locations of the one or more samples (e.g., byte offsets of the one or more samples), types of the one or more samples (e.g., video, audio), lengths of the one or more samples, motion features of the one or more samples if the one or more samples are video samples and any other features about the one or more samples.

The content tables 304 include one or more content tables generated by the table generator 208. For example, the table generator 208 generates one or more content tables based at least in part on the one or more file headers that are received from the parser 206. In one embodiment, the table generator 208 analyzes the one or more file headers and determines one or more features for one or more samples in the content file such as an MP4 video file based on the analyzing. The table generator 208 generates one or more content tables based at least in part on the determined one or more features for samples in the content file such as the MP4 video file. For example, one entry in the content table includes one or more of a sample ID, a type of the sample, a byte offset, a length, a time offset and a motion feature of the sample. One example of the content table will be described in detail below with reference to FIG. 4.

In one embodiment, the content tables 304 also include one or more tables of a content table. For example, the content tables 304 include a table of content that stores one or more corresponding relationships between one or more content tables and one or more content files such as MP4 video files.

The tags 306 include tags generated by the packaging module 212. For example, the packaging module 212 generates a tag header based at least in part on the one or more content tables. The packaging module 212 prepends the tag header to a corresponding sample to form a tag. Therefore, a tag includes a tag header and a sample. In one embodiment, the tag header includes one or more of a tag type, a tag length, a time offset and a motion feature.

### Example Content Table

Using data retrieved from the asset hosting site 100, the format module 150 generates one or more content tables describing the locations and/or other features of the one or more samples in the content file. For example, FIG. 4 illustrates one embodiment of a content table 400 generated by the table generator 208 of the format module 150. The content table 400 includes a table ID 401. The table ID identifies the content table 400. In one embodiment, the table ID is included in a table of content to indicate that the content table 400 corresponds to a content file such as a video file.

The content table 400 also includes a sample ID 402 and sample features 404, 406, 408, 410, 412. For example, the content table 400 includes a type 404 identifying the type of the frame that a sample corresponds to. The content table 400 includes a byte offset 406 that indicates the start byte of the sample in the content file. The content table 400 also includes a length 408 identifying a length in byte of a sample. In one embodiment, the content table 400 includes a time offset 410 indicating the start time of the frame that the sample corresponds to. The content table 400 also includes a motion feature 412. If the type 404 for a sample is video, which means the sample corresponds to a video frame, the motion feature 412 for the sample is either “key” or “intermediate” indicating the video frame is either a key frame or an intermediate frame respectively.

Persons of ordinary skill in the art will recognize that the content table 400 may include different and/or additional data than that identified above and illustrated in FIG. 4.

### Methods

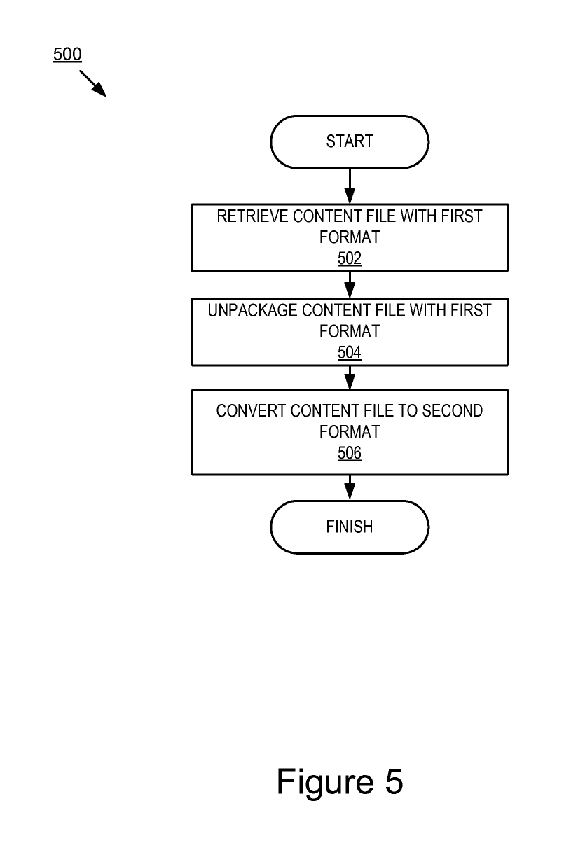

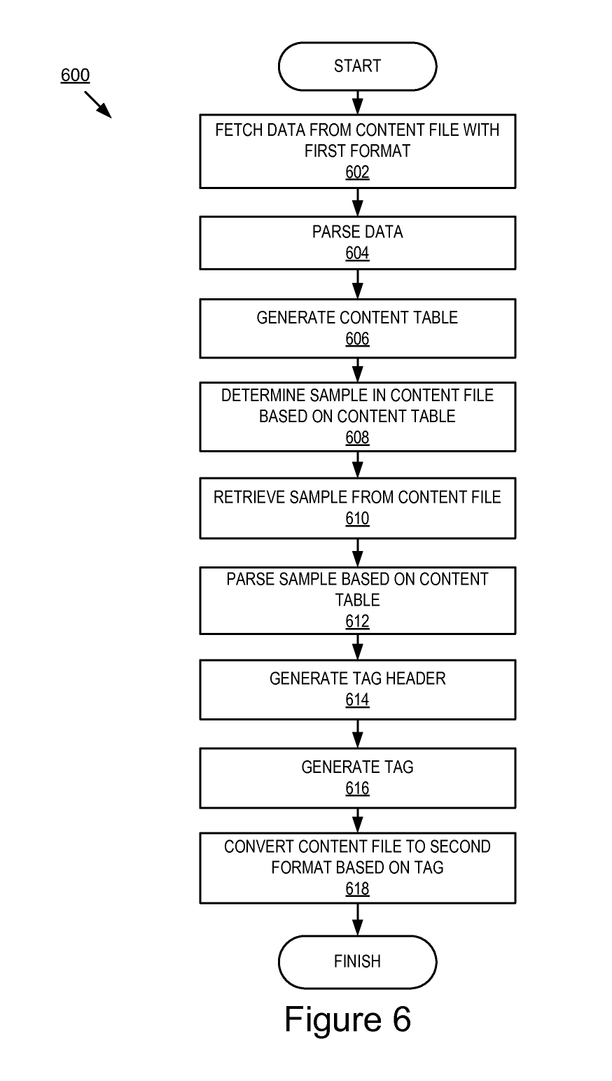

FIGS. 5-6 depict various methods 500 and 600 performed by the system described above with reference to FIGS. 1-4.

FIG. 5 is a flow diagram depicting one embodiment of a method 500 for converting a content file from a first format to a second format. The format module 150 retrieves 502 a content file with a first format. For example, the content file is a video file with an MP4 video file format. In one embodiment, the format module 150 retrieves data in the MP4 video file that includes one or more file headers from the asset hosting site 100.

At step 504, the format module 150 unpackages (or demuxes) the content file with the first format. In one embodiment, the format module 150 parses the retrieved data in the content file such as an MP4 video file at byte level for one or more file headers. The format module 150 generates one or more content tables based at least in part on the one or more file headers. The format module 150 then retrieves and parses one or more samples in the content file each including one or more bytes based at least in part on the one or more content tables. In this way, the format module 150 unpackages (or demuxes) the content file such as an MP4 video file into one or more samples.

At step 506, the format module 150 converts the content file from the first format to the second format. For example, the format module 150 converts the content file from the MP4 video file format to an FLV file format by packaging (or muxing) the one or more samples. In one embodiment, the format module 150 generates one or more tags based at least in part on the one or more samples by prepending a tag header to each sample. By arranging the one or more tags in sequence based on the locations of the one or more samples in the MP4 video file, the format module 150 converts the MP4 video file to an FLV file.

FIG. 6 is a flow diagram depicting one embodiment of another method 600 for converting a content file from a first format to a second format. The fetching module 204 fetches 602 data from a content file with a first format. In one embodiment, the fetching module 204 generates a request for data in a content file with the first format responsive to a user 125 requesting to view the content file in the second format if the content file with the second format is not available. The fetching module 204 sends the request to the asset hosting site 100 through the communication interface 202 to fetch the data from the content file with the first format stored in the asset hosting site 100.

At step 604, the parser 206 parses the data that is fetched from the content file with the first format. For example, the parser 206 receives the data in the content file with the first format such as an MP4 video file from the asset hosting site 100 via the communication interface 202. The parser 206 parses the data at byte level for one or more file headers. In one embodiment, an MP4 video file header includes supplemental data describing the locations of one or more samples in the MP4 video file. In another embodiment, the MP4 video file header also includes supplemental data indicating one or more of types of the one or more samples, lengths of the one or more samples, motion features of the one or more samples if the one or more samples are video samples and any other features about the one or more samples.

At step 606, the table generator 208 generates one or more content tables. In one embodiment, the table generator 208 generates a content table based at least in part on the one or more file headers. For example, the table generator 208 generates a content table including one or more of a type of sample, a byte offset of a sample, a length of a sample, a time offset of a sample and a motion feature of a sample if the sample corresponds to a video frame in the video file.

At step 608, the determining module 210 determines one or more samples in the content file based at least in part on the one or more content tables. For example, according to the locations of the one or more samples that are indicated in the one or more content tables, the determining module 210 determines the one or more samples in the content file such as the MP4 video file.

At step 610, the determining module 210 retrieves the one or more samples from the content file. For example, the determining module 210 retrieves the one or more samples in the MP4 video file from the asset hosting site 100 based at least in part on the determination of the locations of the one or more samples in the MP4 video file.

At step 612, the determining module 210 parses the one or more samples based at least in part on the one or more content tables. In one embodiment, the determining module 210 includes a parser that parses the one or more samples based at least in part on the one or more content tables. In another embodiment, the determining module 210 sends the retrieved one or more samples to the parser 206 to parse the one or more samples based at least in part on the one or more content tables. In either embodiment, the one or more samples are parsed at byte level based at least in part on one or more of the byte offset, the length in byte and other features included in the one or more content tables.

At step 614, the packaging module 212 generates one or more tag headers for the one or more samples. For example, the packaging module 212 generates 13 or 16 bytes as a tag header that describes the features for an audio sample or a video sample respectively.

At step 616, the packaging module 212 generates one or more tags based at least in part on the one or more samples and the one or more tag headers. For example, the packaging module 212 prepends a tag header to a corresponding sample to form a tag.

At step 618, the packaging module 212 converts the content file from the first format to a second format based at least in part on the one or more tags. For example, by arranging the one or more tags in sequence based on the locations of the one or more samples in the content file with the first format such as the MP4 video file, the packaging module 212 converts the content file from the first format such as the MP4 format to the second format such as an FLV format.

The foregoing description of the embodiments of the specification has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies and other aspects are not mandatory or significant, and the mechanisms that implement the specification or its features may have different names, divisions and/or formats. Furthermore, as will be apparent to one of ordinary skill in the relevant art, the modules, routines, features, attributes, methodologies and other aspects of the disclosure can be implemented as software, hardware, firmware or any combination of the three. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the disclosure is in no way limited to implementation in any specific programming language, or for any specific operating system or environment. Accordingly, the disclosure is intended to be illustrative, but not limiting, of the scope of the specification, which is set forth in the following claims.

What is claimed is:

1. A method for converting a content file from a first format to a second format, the method comprising:
parsing data in the content file with the first format for one or more file headers;
generating one or more content tables based at least in part on the one or more file headers;
determining one or more samples in the content file with the first format based at least in part on the one or more content tables;
generating one or more tags based at least in part on the one or more samples; and
converting the content file from the first format to the second format based at least in part on the one or more tags.

2. The method of claim 1, wherein the content table comprises one or more of a table identifier, a table name, a sample identifier, a sample name, a type, a byte offset, a length, a time offset and a motion feature.

3. The method of claim 1 further comprises:
retrieving the one or more samples from the content file with the first format; and
parsing the one or more samples based at least in part on the one or more content tables.

4. The method of claim 1, wherein generating one or more tags based at least in part on the one or more samples further comprises:
generating one or more tag headers based at least in part on the one or more content tables; and
prepending the one or more tag headers to the one or more samples.

5. The method of claim 5, wherein the tag header comprises one or more of a tag type, a tag length, a time offset, a motion feature.

6. The method of claim 1 further comprises:
fetching the data from the content file with the first format.

7. The method of claim 1, wherein the first format comprises an MPEG-4 file format and the second format comprises a Flash Video file format.

8. A system for converting a content file from a first format to a second format, the system comprising:
a parser for parsing data in the content file with the first format for one or more file headers;
a table generator communicatively coupled to the parser for receiving the one or more file headers and generating one or more content tables based at least in part on the one or more file headers;
a determining module communicatively coupled to the table generator for receiving the one or more content tables from the table generator and determining one or more samples in the content file with the first format based at least in part on the one or more content tables; and
a packaging module communicatively coupled to the determining module for receiving the one or more samples in the content file with the first format and generating one or more tags based at least in part on the one or more samples, the packaging module converting the content file from the first format to the second format based at least in part on the one or more tags.

9. The system of claim 8, wherein the content table comprises one or more of a table identifier, a table name, a sample identifier, a sample name, a type, a byte offset, a length, a time offset and a motion feature.

10. The system of claim 8, wherein the determining module further retrieves the one or more samples from the content file with the first format and parses the one or more samples based at least in part on the one or more content tables.

11. The system of claim 8, wherein generating one or more tags based at least in part on the one or more samples further comprises:
generating one or more tag headers based at least in part on the one or more content tables; and
prepending the one or more tag headers to the one or more samples.

12. The system of claim 8, wherein the tag header comprises one or more of a tag type, a tag length, a time offset, a motion feature.

13. The system of claim 8 further comprising:
a fetching module communicatively coupled to the parser for fetching the data from the content file with the first format.

14. The system of claim 8, wherein the first format comprises an MPEG-4 file format and the second format comprises a Flash Video file format.

15. A computer program product comprising a non-transitory computer readable medium encoding instructions that, in response to execution by a computing device, cause the computing device to perform operations comprising:
parsing data in the content file with the first format for one or more file headers;
generating one or more content tables based at least in part on the one or more file headers;
determining one or more samples in the content file with the first format based at least in part on the one or more content tables;
generating one or more tags based at least in part on the one or more samples; and
converting the content file from the first format to the second format based at least in part on the one or more tags.

16. The computer program product of claim 15, wherein the content table comprises one or more of a table identifier, a table name, a sample identifier, a sample name, a type, a byte offset, a length, a time offset and a motion feature.

17. The computer program product of claim 15, wherein the computer readable medium encoding instructions that, in response to execution by a computing device, causes the computing device to further perform steps comprising:
retrieving the one or more samples from the content file with the first format; and
parsing the one or more samples based at least in part on the one or more content tables.

18. The computer program product of claim 15, wherein generating one or more tags based at least in part on the one or more samples further comprises:
generating one or more tag headers based at least in part on the one or more content tables; and
prepending the one or more tag headers to the one or more samples.

19. The computer program product of claim 15, wherein the tag header comprises one or more of a tag type, a tag length, a time offset, a motion feature.

20. The computer program product of claim 15, wherein the computer readable medium encodes instructions that, in response to execution by a computing device, causes the computing device to further perform steps comprising:
fetching the data from the content file with the first format.

21. The computer program product of claim 15, wherein the first format comprises an MPEG-4 file format and the second format comprises a Flash Video file format.
